(19) United States
(12) Patent Application Publication
(10) Pub. No.: US 2007/0243107 A1
(43) Pub. Date: Oct. 18, 2007

(54) Hand-held gas detector and method of gas detection

(76) Inventors: D. Bruce Chase, Wilmington, DE (US); Daniel B. Laubacher, Wilmington, DE (US); James D. McCambridge, Swarthmore, PA (US); John Carl Steichen, Landenberg, PA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/601,952

(22) Filed: Nov. 20, 2006

Related U.S. Application Data
(60) Provisional application No. 60/791,743, filed on Apr. 13, 2006.

(51) Int. Cl. G01N 21/17

(52) U.S. Cl. 422/83; 422/91

(57) ABSTRACT

A gas detector includes a predetermined amount of a sensor material having at least one optical property which changes as a result of reaction with a target gas and a photometric device operable to measure the intensity of said at least one optical property of the sensor material. The reaction is such that there is a one-to-one relationship between the magnitude of the intensity of at least one optical property and the concentration of the target gas in the gas sample whereby the concentration of the target gas in the gas sample may be determined from the measured magnitude of the intensity of said at least one optical property after the passage of the predetermined volume of gas sample over the given area of sensor material.

This application claims the benefit of U.S. Provisional Application No. 60/791,743, filed on Apr. 13, 2006, which is incorporated in its entirety as a part hereof for all purposes.

### FIELD OF THE INVENTION

This invention relates to a gas detector apparatus and to a method for detecting the presence of a target gas in a gas sample and, particularly, to a gas detector apparatus and gas detection method for detecting a toxic industrial chemical in an air sample.

### BACKGROUND OF THE INVENTION

Gas detectors for detecting the presence of a particular gaseous material (a “target” gas) in a gaseous sample have long used a sensor material that undergoes a change in one or more of its optical properties as a result of reaction with the target gas. Representative of such gas detectors are those devices known as “Dräger tubes” manufactured and sold by Dräger Safety AG & Co. KGaA, Luebeck, Germany.

In a typical implementation the sensor material is distributed along an enclosed sensing channel suitably formed in a housing or on a substrate. For example, the sensor material may take the form of an elongated strip disposed along a groove in a substrate or as a coated lining of a tubular member. The gaseous sample may be time-metered into the channel over a period of time or introduced as a fixed volume.

As the gaseous sample advances through the channel any target gas that is present in the sample progressively chemically interacts with the sensor material. This interaction between the target gas and the sensor material causes one or more optical properties of the sensor material to be altered. The physical extent of the sensor material exhibiting the altered optical property (e.g., distance along the channel) may thus be used to provide a measure of the concentration of the target gas in the sample. This distance is readily able to be determined using a photometric device, such as a spectrophotometer.

The principles of operation of such a typical prior art implementation may be understood from the stylized schematic illustrations shown in FIGS. 1A through 1D. In FIGS. 1A through 1D a sensor material S is disposed in the form of an elongated stripe extending over a predetermined portion of a sensing channel C from the channel inlet I to the channel outlet E. The virgin (un-reacted) sensor material S is shown as stipled.

A gaseous sample G containing an unknown concentration of a target gas T (shown as dots) is introduced at the inlet I of the channel C. As the volume of the sample T propagating through the channel increases, an increasing area of the surface of the sensor material S is progressively exposed to the target gas T until substantially all of the available sensor material in that area reacts with the gas. Thus, an increasing area of the sensor S progressively changes at least one of its optical properties (e.g., reflective intensity) due to chemical reaction with target gas T. This progressive change in optical property is illustrated in FIGS. 1B through 1C by the increasing density and area of cross-hatching. Eventually the sensor material S within the reacted area becomes saturated and no further change in optical property occurs.

Eventually, after the full volume of the sample G traverses the full extent of the channel, the length L of the sensor S exhibiting the changed optical property is measured. From this length L (FIG. 1D) the concentration of the target gas T in the sample G is determined.

As should be understood from the foregoing, since the concentration of the target gas is calibrated to the physical extent of the portion of the sensor material having the changed optical property, a prior art gas detector of the type discussed requires that the sensor material occupy a relatively extensive portion of the length of the channel. This requires physical space. Moreover, the entire volume of the sample under test must be afforded the opportunity to traverse the full length of the channel before the full extent of the portion of the sensor material having the changed optical property may be determined. This takes time. Both of these requirements are perceived as disadvantageous.

Accordingly, it is believed that there is a need for a relatively compact gas detector apparatus that can rapidly detect multiple gases and quickly provide the results. Especially needed is such a detector that can be hand-held.

### SUMMARY OF THE INVENTION

In one aspect the present invention is directed to a gas detector comprising:
(a) a predetermined amount of a sensor material having at least one optical property which changes as a result of reaction with a target gas, and
(b) a photometric device operable to measure the intensity of said at least one optical property of the sensor material,

the reaction being such that there is a one-to-one relationship between the magnitude of the intensity of at least one optical property and the concentration of the target gas in the gas sample,

whereby the concentration of the target gas in the gas sample may be determined from the measured magnitude of the intensity of said at least one optical property after the passage of the predetermined volume of gas sample over the given area of sensor material.

In one particular embodiment, the gas detector includes a detector cartridge comprising a substrate to which is attached two or more sensor materials each having at least one optical property which changes as a result of reaction with a target gas. The sensor materials may be the same or different materials. The reaction of each sensor material is such that there is a one-to-one relationship between the magnitude of the intensity of at least one optical property and the concentration of the target gas in the gas sample, whereby the concentration of each target gas in the gas sample may be determined from the measured magnitude of the intensity of said at least one optical property after the passage of the predetermined volume of gas sample over the given area of a respective sensor material.

The detector further includes an air sampling system to provide an air sample to the detector cartridge and a photometric device to measure the change in intensity of said at least one optical property of each sensor material. A display for displaying to a viewer the concentration of the target gas in the gas sample in accordance with the magnitude of the change in intensity of said at least one optical property of each sensor material is provided.

In another aspect the present invention is directed to a method for detecting a target gas in a gas sample comprising the steps of:
(a) contacting a gas sample having a target gas therein with a given area of a sensor material, the sensor material having at least one optical property that changes as a result of a reaction with the target gas, the reaction of the sensor material is such that there is a one-to-one relationship between the magnitude of the intensity of at least one optical property and the concentration of the target gas in the gas sample, whereby the concentration of the target gas in the gas sample may be determined from the measured magnitude of the intensity of said at least one optical property after the passage of the predetermined volume of gas sample over the given area of a respective sensor material;
(b) measuring the change in said at least one optical property of the sensor material as a result of contact with the target gas; and
(c) determining the concentration of the target gas in the gas sample from the measured magnitude of the intensity of said at least one optical property after the passage of the predetermined volume of gas sample over the given area of sensor material.

In both its apparatus and method aspects the present invention may be implemented by disposing a plurality of different sensor materials, each reactive with a different target gas, in locations wherein each of the sensor materials is placed in reactive contact with the target gas in the gas sample. The apparatus and method of this invention is particularly useful for detecting toxic industrial chemicals in an air sample. Preferably, the gas detector is a hand-held gas detector.

### BRIEF DESCRIPTION OF THE DRAWINGS

This invention will be more fully understood from the following detailed description, taken in connection with the accompanying drawings, which form a part of this application and in which:

FIGS. 1A through 1D are stylized schematic drawings illustrating the principles of operation of such a typical prior art gas detector;

FIG. 2 is a stylized schematic drawing illustrating the basic structural elements of a gas detector apparatus in accordance with the present invention;

FIGS. 3A through 3D are a stylized schematic drawings illustrating the principles of operation of a gas detector apparatus and gas detection method in accordance with the present invention;

FIG. 4 is a graphical representation illustrating the change in intensity of the optical property of the sensor material of FIG. 3A (ordinate) as plotted against exposure to increasing concentrations of a sample gas (abscissa), as depicted in FIGS. 3B and 3C;

FIG. 5 is a highly stylized, exploded perspective illustration of a preferred implementation of a hand-held gas detector device employing the principles of the present invention;

FIG. 6 is an enlarged plan view of the surface of a substrate used in the gas detector of the present invention;

FIG. 7 is a sectional view through the cartridge module taken along section lines 7-7 in FIG. 5;

FIG. 8 is a flow diagram of a computer program executed by a computer within the electronics module of the detector device shown in FIG. 5;

FIG. 9A through 9C are structures illustrating the coupling chemistry that may be used to bind a sensor molecule to a high surface area silica particle; and

FIG. 10 is a plot of the diminution in reflected intensity versus time (as indicated by camera frame) for the Example.

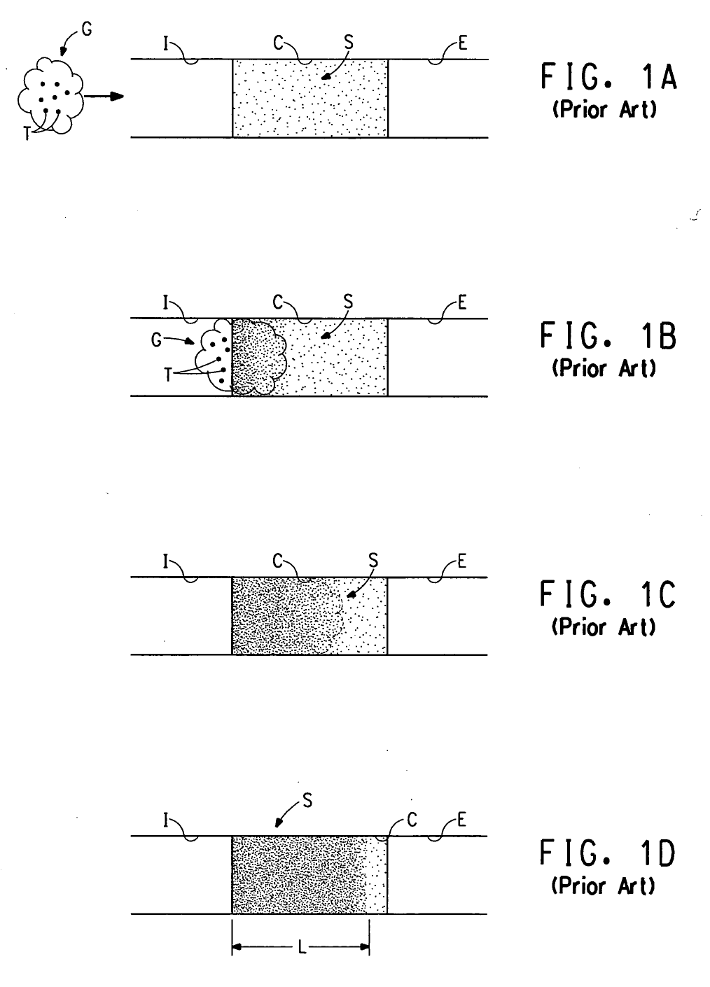

### DETAILED DESCRIPTION OF THE INVENTION

Throughout the following detailed description similar reference characters refer to similar elements in all Figures of the drawings.

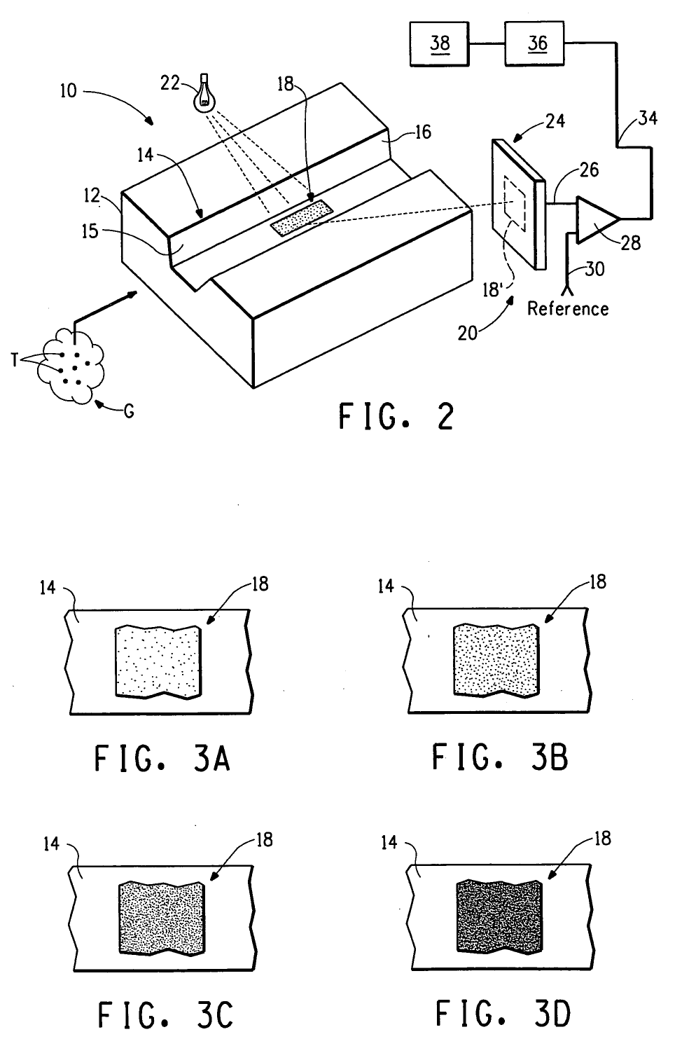

FIG. 2 is a stylized schematic drawing illustrating the basic structural and functional elements of a gas detector generally indicated by the reference character 10 in accordance with the present invention.

The detector 10 includes a substrate 12 in which a flow channel 14 is formed. The flow channel 14 has an inlet 15 and an outlet 16.

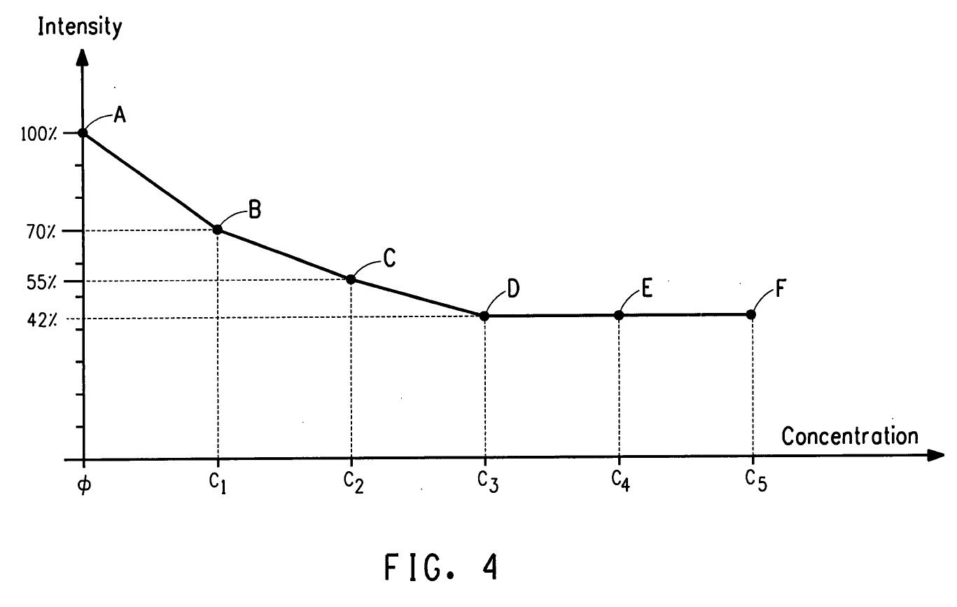

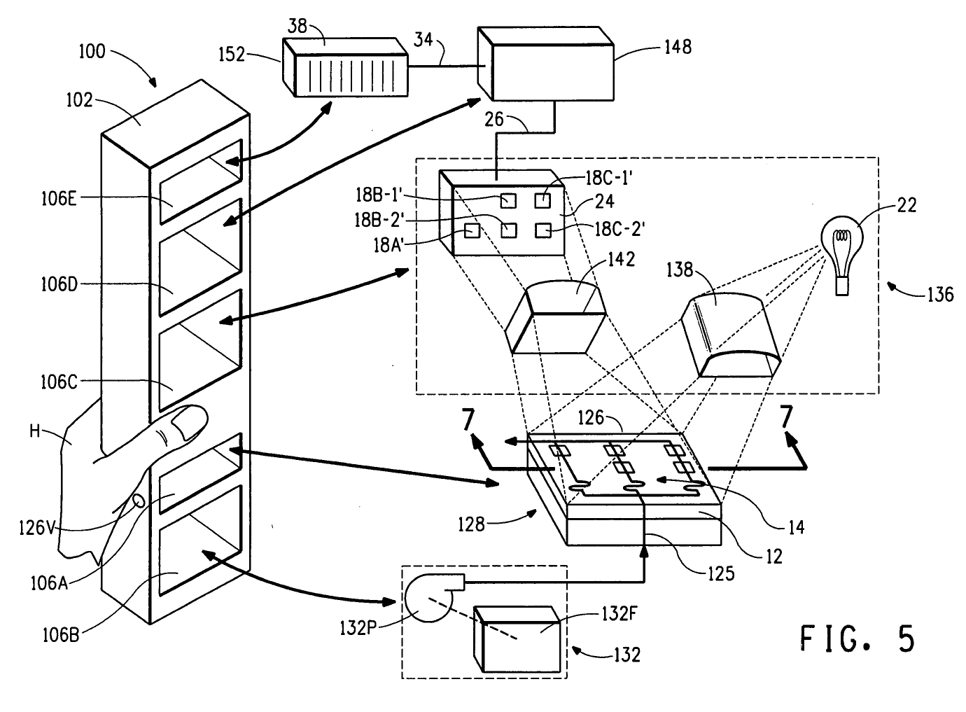

A plaque 18 of a sensor material is located on the substrate 12 at a predetermined position along the channel 14. Enlarged diagrammatic plan views of the plaque 18 of the sensor material are shown in FIGS. 3A through 3D. The plaque 18 may occupy all or some predetermined portion of the surface area of the channel 14 or all or some predetermined portion of the volume of the channel 14. The plaque 18 contains a predetermined amount of the sensor material available for reaction distributed substantially evenly over the surface of the channel 14 that it occupies.

The sensor material in the plaque 18 may be any of a variety of materials that reacts upon exposure to differing concentrations of a predetermined target gas by changing at least one of its optical properties. For example, the ability of the sensor material in the plaque 18 to absorb or reflect one or more wavelengths of light in ultraviolet, visible, or infrared regions of the spectrum, as manifested by the intensity of radiation reflected from the material, is an optical property of the material that may be expeditiously monitored. Other useful optical properties include, but are not limited to, fluorescence or chemiluminescent reactivity. Materials used in the prior art detectors discussed earlier are useful as the sensor material(s) for the present invention.

As will be developed, the predetermined amount of the sensor material distributed over the area of the plaque 18 is selected such that a reaction occurs in the sensor material when it is exposed to the target gas in a concentration range of interest in the gas sample. In the preferred instance the plaque is sized such that, aside from minor local variations, the reaction occurs essentially uniformly over substantially the entire surface of the area of the sensor material.

The reaction between the target gas and the sensor material is such that there is a one-to-one relationship between the magnitude of the intensity of at least one optical property and the concentration of the target gas in the gas sample. Thus, the concentration of the target gas in the gas sample is able to be determined from the measured magnitude of the intensity of said at least one optical property after passage of a predetermined volume of gas sample over the given amount of sensor material.

A photometric device generally indicated by the reference character 20 is positioned to detect changes in intensity of the optical property (e.g., reflective intensity) of the sensor material. The photometric device 20 includes a source 22 positioned to direct interrogating radiation at one or more selected wavelengths toward the plaque 18. In practice, as will be developed, it may desirable to use interrogating radiation over a spectrum of wavelengths.

For instance it may be desirable to use a wavelength or a range of wavelengths for which the optical property exhibits the maximum change in intensity upon reaction of the plaque with the target gas.

Radiation reflected from the plaque 18 produces an electronic image 18′ on a suitable electronic imaging device 24, such as a charge coupled diode array. An electronic signal derived from the electronic image 18′ and representative of the reflected intensity from the plaque 18 is generated on a line 26.

The reflected intensity signal 26 is compared by a comparator 28 to a reference intensity signal on a line 30. The reference intensity signal may be derived from the sensor material measured at a time earlier than the time of the analysis in question, as at a time prior to the initial reaction with a target gas.

A signal representative of the measured magnitude of the intensity after passage of the predetermined volume of gas sample over the given amount of sensor material (as compared to the reference intensity signal) is generated from the comparator 28 on a line 34. The signal on the line 34 is used to address a table of calibrated values relating concentration of a target gas to a measured intensity. The table is stored in a memory 36. Information indicating the concentration of the target gas T in the sample is displayed to a viewer over a monitor or other display device 38.

The principles of operation of the gas detector 10 may be more fully understood with reference to FIGS. 3A through 3D taken in connection with FIG. 4.

Prior to the introduction into the channel 14 of a predetermined volume of a gas sample G containing some concentration of a target gas T the plaque 18 of sensor material may appear as shown diagrammatically in FIG. 3A. The predetermined optical property (e.g., reflected intensity) of the virgin plaque 18 of sensor material has some initial value (e.g., 100%). The magnitude of this optical property is quantitatively illustrated at point A in FIG. 4 for this initial condition (i.e., zero concentration of target gas).

Assume the virgin plaque 18 (FIG. 3A) of sensor material is exposed to a predetermined volume of the gas sample containing a first concentration C, of a target gas. At this concentration only a portion of the sensor material available for reaction reacts with the target gas. This is diagrammatically suggested by the increased shading over the surface area of the sensor material (FIG. 3B). Owing to this reaction with the target gas the reflected intensity of the sensor material diminishes (e.g., to 70%; as illustrated at point B in FIG. 4).

However, if the virgin plaque 18 (FIG. 3A) of sensor material were exposed to the same predetermined volume of the gas sample containing a second, greater, concentration C₂ of a target gas, a greater portion of the sensor material available for reaction would react with this concentration of target gas. This is diagrammatically suggested by the depiction in FIG. 3C of the shading over the surface area of the sensor material. The greater concentration C₂ of the target gas would increase the degree of reaction as represented by the increased shading of the surface area of the sensor material. As a result, the intensity of radiation reflected from the sensor material is diminished (e.g., to 55%, as illustrated at point C in FIG. 4).

If the virgin plaque 18 (FIG. 3A) of sensor material were exposed to the same predetermined volume of the gas sample containing a sufficiently high concentration C₃ of a target gas, all of the available sensor material in the plaque would react with target gas. This is diagrammatically suggested by the full shading over the sensor material (FIG. 3D). The intensity of radiation reflected from the sensor material would diminish to a minimum value (e.g., to 42%, as illustrated at point D in FIG. 4). Since the sensor is saturated at concentration C₃ exposures of the virgin plaque 18 (FIG. 3A) to higher concentrations C₄ or C₅ would produce substantially the same effect (FIG. 3D) with no additional decreases in reflected intensity (points E and F in FIG. 4).

It should be able to be observed that in the region of FIG. 4 containing points A through D there exists a one-to-one correspondence between the measured intensity and the concentration of the target gas in a predetermined volume of the gas sample. The present invention capitalizes on this one-to-one correspondence. By “one-to-one correspondence” it is meant that there is a unique specific value of target gas concentration associated with each and every value of intensity. It is noted that although the change in optical property (intensity) is shown to be substantially linear for purposes of this discussion, such a linear relationship is not necessarily required.

In the region of FIG. 4 containing points D through F the same value of intensity occurs over a range of target gas concentrations. This region of the curve of FIG. 4 represents the saturation region of the sensor region that is used by the prior art to detect concentrations of target gas.

It should be appreciated that the foregoing discussion of FIGS. 3 and 4 is presented in terms of the actual observed intensity. However, for a given sensor material, target gas and optical property either an increase or decrease in intensity can occur and serve as the basis of the plot. If the diminution (decrease) of observed intensity is used as the measure, FIG. 3A would depict a zero decrease, FIG. 3B would depict a 30% decrease, FIG. 3C would depict a 45% decrease diminution and FIG. 3D would depict a 58% decrease.

In accordance with the present invention the magnitude of the change in intensity of an optical property produced by the passage of a predetermined volume of a gas sample over a given amount of sensor material is calibrated to a known concentration of the target gas in a predetermined volume of gas sample. A table of calibrated values relating target concentration to diminution in intensity is stored in the memory 36. Thereafter, in use, changes in the optical property of that given amount of a sensor material may be used to determine an unknown concentration of the target gas in the same predetermined volume of a gas sample.

Because the change in optical property is used to determine the unknown concentration of the target gas, only a relatively small area of sensor material and a relatively short time span are required. This enables a detector 10 embodying the present invention to be implemented in a compact, preferably hand-held device, operative to provide an indication of a concentration of a target gas in a relatively short time.

FIG. 5 illustrates a highly stylized, exploded perspective view of an implementation of a hand-held gas detector device generally indicated by the reference character 100 embodying the functional elements and operative principles of the present invention as described in connection with FIGS. 2 through 4. Structural and functional elements corresponding to those in FIG. 2 are indicated by the same reference characters. It should be appreciated that depiction hand-held gas detector device shown in FIG. 5 may be modified in any of a variety of ways for convenience of construction and/or usage.

The detector device 100 includes a housing 102 fabricated of any suitable material, such as a durable plastic, whereby the detector 100 may be used in hostile environments, such as a factory floor. As suggested diagrammatically in FIG. 5 the housing 102 is sized so as to be conveniently grasped in the hand H of a user. The housing 102 has recesses 106A through 106E formed therein for receipt of various functional modules included in the detector 100.

The main functional element of the detector 100 is, as discussed earlier, the substrate 12. The substrate 12 may be preferably fabricated from silicon, although any suitable polymer, glass, or other material may be used. The substrate 12 has one or more channels generally indicated by the reference character 14 formed therein. In the embodiment illustrated in FIGS. 5 through 7 the substrate 12 has a network of three channels 14A, 14B and 14C formed therein. Any convenient number of channels 14 may be provided on the substrate 12. Each channel is fabricated by any conventional microfabrication technique, such as photolithography. Preferably, the channels 14A, 14B and 14C are produced by etching a silicon substrate.

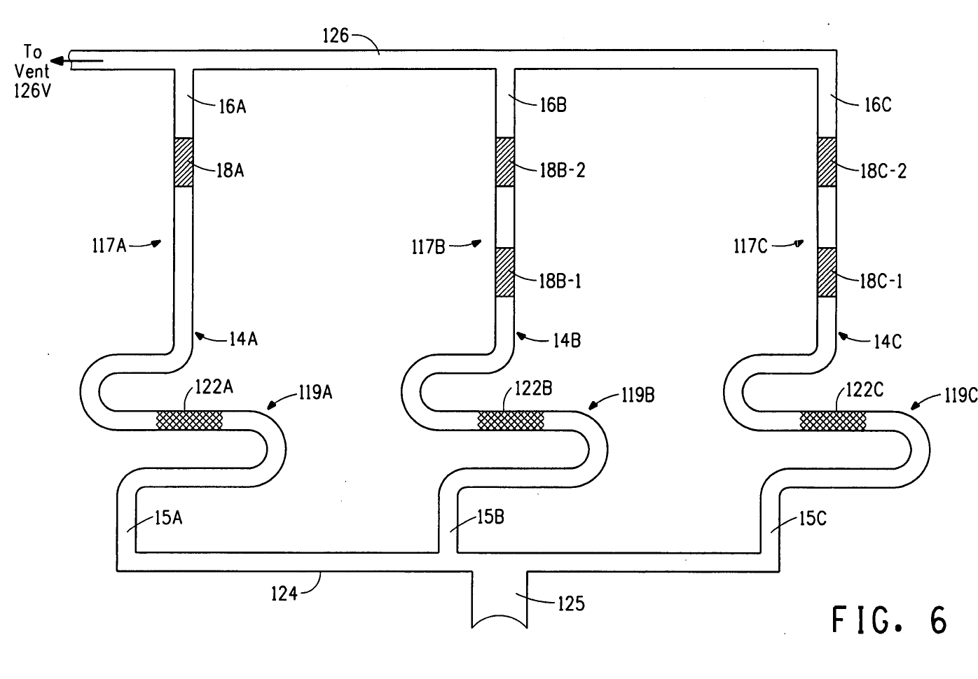

As best shown in FIG. 6 each channel 14A, 14B and 14C has a respective inlet 15A, 15B and 15C and a corresponding outlet 16A, 16B and 16C. Each channel 14A, 14B and 14C has a respective detection region 117A, 117B, 117C disposed between the channel inlet and outlet. The detection region 117 of each channel has one or more plaque(s) 18 each containing a predetermined amount of sensor material therein. As particularly illustrated the channel 14A includes only a single plaque 18A, while the channel 14B and 14C contain two plaques 18B-1, 18B-2 and 18C-1, 18C-2, respectively. Any convenient number of plaques may be provided in a given channel.

The plaques 18 of sensor material can be arranged in any desired fashion. Plaques of different sensor materials disposed in one given channel can be reactive with respective different target gases.

Plaques of a particular sensor material reactive with a given target gas may be placed in the same or different channels thereby to detect different concentration ranges of the same target gas. In such a case the sensor material may contain different numbers of reactive sites. It should also be noted that if the sensor materials for different concentration ranges are disposed in the same channel some accommodation must be made in calibrating downstream plaque(s) to take into account reactions of the target gas with plaque(s) upstream of a given plaque.

Alternatively, plaques of different sensor materials, each reactive with the same target gas, may be placed in different channels thereby to detect different concentration ranges of the same target gas.

Every plaque 18 presents a predetermined amount of sensor material available for reaction. The sensor material is distributed substantially evenly within the channel that it occupies. The sensor materials can be made available for reaction by being attached to high surface area micro-particles or nano-particles (silica, for example) to produce appropriately sensitive detection. The high surface area structures can be aerogels, clay-assisted agglomerations of micron or nano-scale silica or other oxide materials.

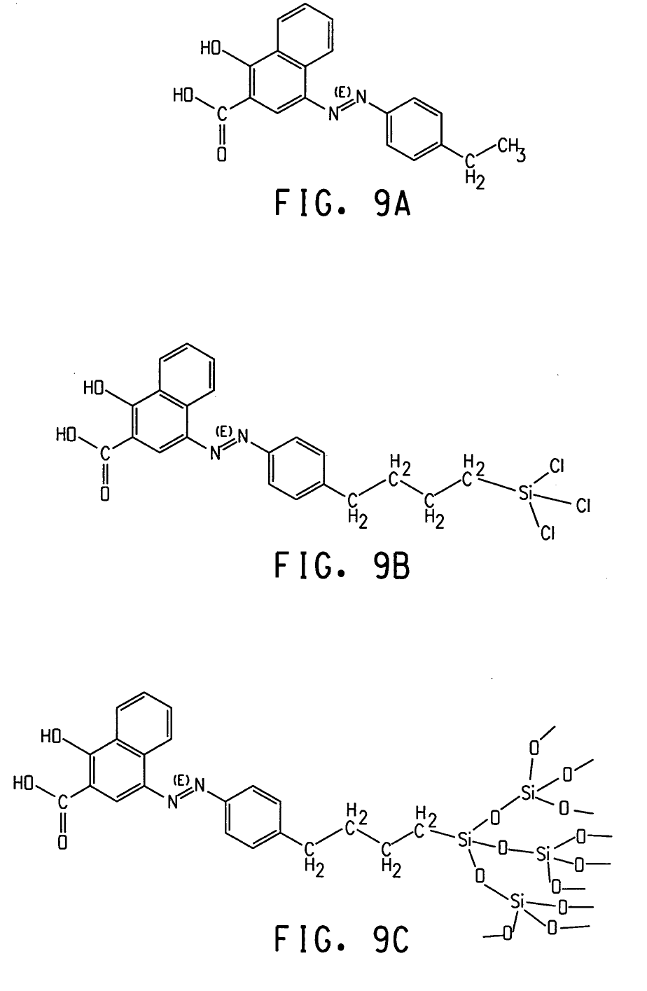

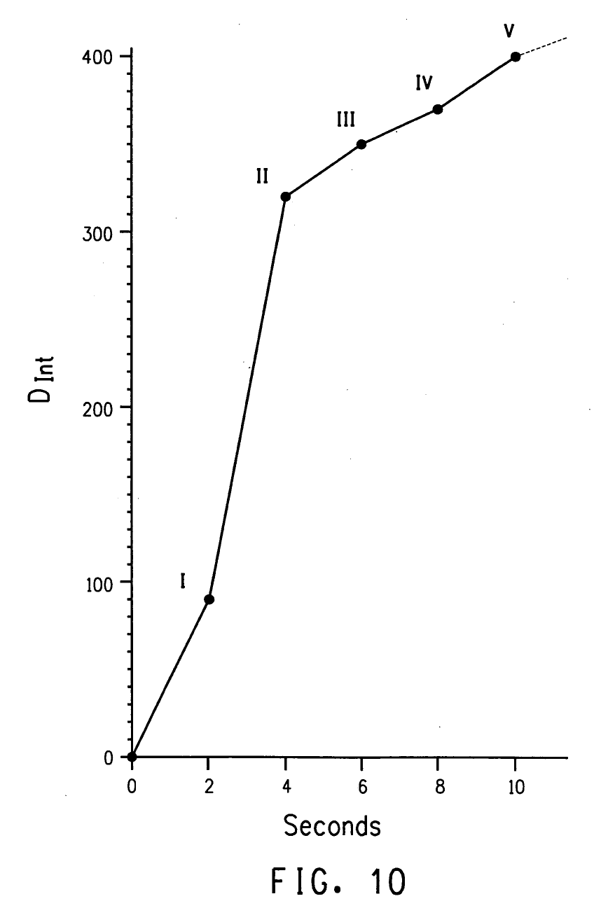

An example of the coupling chemistry that can be used to bind a sensor molecule to a high surface area silica particle is illustrated in FIGS. 9A through 9C wherein the yellow indicator dye p-ethoxyphenyl-azi-α-hydroxynaphthoic acid (PEN) is attached to a high surface area silica particle. The structure for PEN is shown in FIG. 9A. PEN is modified by extending the aliphatic chain and terminating the chain with SiCl₃ as shown in FIG. 9B. This modification leaves the basic electronic structure and reaction chemistry unchanged. The modified PEN molecule is then contacted with a high surface area silica. The chloro-silane group of the modified PEN molecule reacts with the hydrogens of the OH groups on the surface of the high surface area silica to bind the PEN molecule to the silica as shown in FIG. 9C.

It should be appreciated that although shown as substantially rectangular in configuration the plaque(s) 18 of sensor material may exhibit any desired shape consistent with the particular channel in which the plaque is disposed.

Typically a plaque 18 of sensor material exhibits planar length and width dimensions on the order of one millimeter of less. Preferably, the plaque dimensions are in the range of fifty (50) to one hundred (100) micrometers.

Each channel further includes a respective pretreatment region 119A, 119B and 119B. The pretreatment region is disposed intermediate that channel's detection region 117 and the channel inlet 15. The pretreatment region 119A-119C contains a respective filter or reactive material 122A-122C operative to remove any gases in the gaseous sample that would interfere with the performance of sensor plaques in the channel.

In the arrangement shown each channel communicates at its inlet 15 to an inlet manifold 124. The inlet manifold is connected to a sample supply line 125 as diagrammatically suggested in FIG. 5. The outlet end of each respective channel is connected to an outlet passage 126. The outlet passage 126 is vented through a vent opening 126V provided in the housing 102.

It lies within the contemplation of the present invention that each of the channels could be provided with individual inlets and/or outlets. It should also be understood that although the detection region of each channel is shown as substantially linear and the pretreatment region is shown as serpentine, the various regions of the channels and the channels as a whole could exhibit any desired configuration.

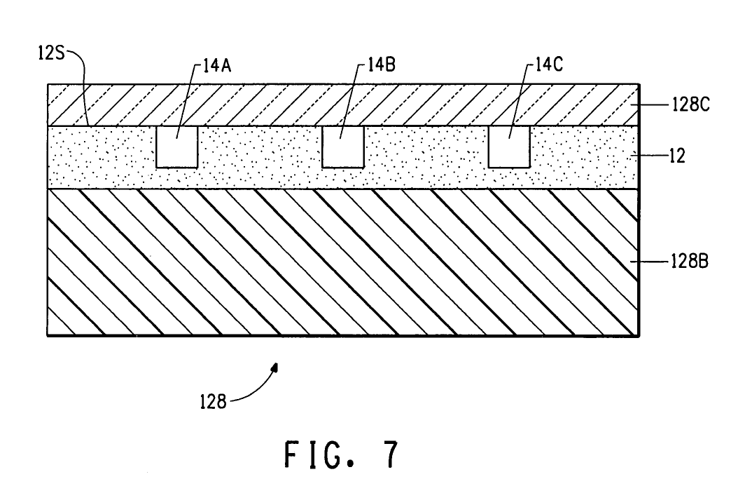

As seen in FIGS. 5 and 7 the substrate 12 is carried within a disposable cartridge module 128 that is itself removably insertable into the recess 106A of the housing 102. In an alternative embodiment the cartridge module 128 may be surface mounted onto a receptive area of the detector housing 102. In either instance it is contemplated that after usage the spent cartridge module is removed from the housing and a fresh cartridge utilized for subsequent tests.

As shown in FIG. 7 the substrate 12 is secured in any convenient manner to the base 128B of the cartridge module 128. The cover 128C of the cartridge module contacts against the surface 12S of the substrate 12 such that the channels 14 therein are isolated from each other. The overall dimensions of the cartridge module 128 is typically on the order of one square inch (6.45 square cm.)

Gas samples to be tested for the presence of a target gas are collected and presented to the substrate 12 by a sampling module 132 (FIG. 5) that mounts in the recess 106B in the housing 102. The sampling module 132 includes a metering pump 132P that supplies a gas sample (e.g., ambient air) to the sample supply line 125 in the detector cartridge module 128. From there the gas sample is conducted to the inlet manifold 124 on the substrate 12. The sampling module 132 includes a filter element 132F sized to eliminate particles above a predetermined threshold, e.g., particles above 50-100 micrometers.

A predetermined volume of a gaseous sample is introduced into the cartridge by continuously metering a gas sample into the detector cartridge module 128. A predetermined fixed volume may be introduced by metering for a predetermined time interval.

The intensity of an optical property of the plaques 18 of sensor material(s) on the substrate 121 is(are) measured using a photometer module 136. The photometer module 136 is received in the recess 106C provided in the housing 102. The photometer module 136 includes a source 22 operative to direct interrogating radiation through a collimating lens 138 toward the substrate 12.

A particular sensor material responds to the presence of a particular target gas by reflecting different wavelengths of light.

Light reflected from the substrate 12 is gathered by a collection lens 142. The light reflected from each respective plaque 18A, 18B-1, 18B-2, 18C-1, 18C-2 is imaged on predetermined regions 18A′, 18B-1′, 18B-2′, 18C-1′, 18C-2′ of an electronic imaging device 24 such as a charge-coupled diode array 24. Each imaged region 18′ on the surface of the electronic imaging device 24 corresponding to a given plaque of sensor material may contain any predetermined number (one or more) pixel locations.

In order to encompass the spectrum believed necessary for the detection of the various possible target gases the source 22 may be implemented using multiple light emitting diodes that each illuminate the substrate with a predetermined wavelength of light. Signals derived from these various regions of the electronic image plane represent the intensity of light reflected from corresponding plaques of sensor materials on the substrate. Alternatively, a filter wheel is interposed in the optical path between a full range source 22 and the electronic imaging device 24. Particularly, the filter wheel is interposed in the reflected light path between the plaques 18 on the surface of the substrate and the imaging device 24. The use of the multiple light emitting diodes or the filter wheel enhances the signal-to-noise ratio of the reflected signal.

The signal representative of a given plaque 18 of sensor material may be based upon a summation of the intensity values derived from the pixel location(s) on the electronic imaging device 24 corresponding to the given plaque 18. The derived signal is applied to an electronics module 148. The electronics module 148 is received within the recess 106D within the housing. The electronics module 148 includes a computer operating in accordance with a program to effect the functions performed by the functional elements 28 through 36 discussed in connection with FIG. 2.

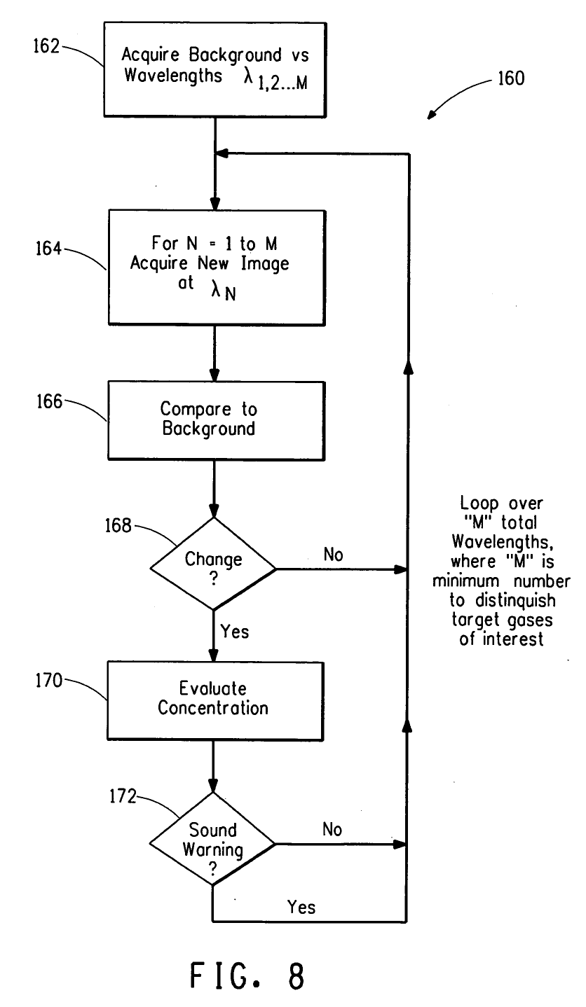

A flow diagram of a computer program 160 executed by a computer within the electronics module 148 is shown in FIG. 8. As noted earlier it is desirable that the plaques of sensor material(s) be interrogating with radiation over a spectrum of wavelengths. The functional blocks 162 to 172 of the program denote the method steps implemented to detect target gasses of interest in a gas sample over a range of M wavelengths. The background intensity from each virgin plaque at each of the M wavelengths is used to define a reference spectrum against which reflected intensities are compared. The program loops over the M wavelengths comparing the reflected intensities spectra with the reference spectrum to evaluate concentration of the target gas(ses) in a sample.

The output of the electronics module 148 is applied to a human interface or display 38 received in the recess 106E.

### EXAMPLE

The production of a table of calibrated values relating concentration to change in intensity may be understood by the following example. Reference characters from FIGS. 5 through 7 corresponding to the structural and functional elements of the example are indicated parenthetically.

A silicon wafer (12) was wet etched to provide ten channels (e.g., 14A) therein. The wafer was one hundred millimeters (100 mm) in diameter and one-half millimeter (0.5 mm) in thickness. Each channel was approximately ninety millimeters (90 mm) long, four millimeters (4 mm) wide and four-tenths millimeter (0.4 mm) deep. A glass cover (128C) was diamond point machined to create an inlet access hole for each channel. An inlet manifold common to all channels was formed in the wafer. Each channel had a separate outlet port.

A plaque (18) of sensing material was disposed in one channel of interest. The sensing material was obtained from a sealed ammonia 2-50 ppm Dräger CMS™ tube manufactured and sold by Dräger Safety AG & Co. KGaA, Luebeck, Germany. The cover was anodically bonded at elevated temperature onto the surface of the wafer to seal the channels. Suitable inlet and outlet fittings were provided using Nanoport™ compression fittings available from Upchurch Scientific Incorporated, Oak Harbor, Wash. 98277.

The detector was mounted on a sixty-by-sixty centimeter (60 cm×60 cm) optical table and was illuminated using a 31-35-30 visible light source (22) formerly available from Bausch and Lomb, Incorporated, Rochester, N.Y.

A Photometrix™ Quantix KAF 1600 thermoelectrically-cooled charge-coupled diode (CCD) device available from Photometrix, Tucson, Ariz. 85706, was used as an electronic imaging device (24). A collection lens (142) was used to focus the image on the CCD. A one hundred five millimeter (105 mm), f/2.8 AF Micro-Nikkor™ available from Nikon USA, Melville, N.Y. 11747, was used as the collection lens.

Gas lines were connected to the compression fittings for the inlet manifold on the substrate and to the outlet fitting for each channel on the substrate. The outlet fitting for each channel was connected to a Varian DS102 vacuum pump available from Varian Incorporated, Palo Alto, Calif. 94304.

A one (1) liter supply plenum was connected to the inlet manifold.

The one liter (1 l) plenum was purged with nitrogen and evacuated to a base pressure below three (3) Torr three times. The manifold was backfilled with eighteen (18) Torr of a mixture of one hundred parts per million (100 ppm) ammonia in nitrogen and pure nitrogen was added to make a total pressure in the manifold eight hundred fifty (850) Torr, corresponding to an effective concentration of two parts per million (2 ppm) ammonia in nitrogen.

Flow rates through the sensor channel were typically one-half (0.5) Torr-liter per second (TL/s).

Images were recorded in twelve (12) bit grayscale. The illumination intensity, f-stop of the lens, and exposure time of the CCD were adjusted to obtain images with maximum recorded intensities near half of full scale. After image acquisition from the camera was begun the plenum was opened and 0.35 second exposures were taken every two (2) seconds. After thirty frames were acquired (approximately one minute) the plenum was closed.

The diminution in reflected intensity relative to the initial intensity was measured for individual pixels located near the inlet end of the sensing materials over the time of the experiment (as indicated by camera frame).

The results are listed in the following Table.

TABLE

| | | | Diminution | Intensity |
|---|---|---|---|---|
| Data | Frame | | In Intensity | Diminution |
| Point | Number | Quantity | (D_{Int} Pixels) | (% Initial Intensity) |
| I | 1 | Q | 90 | 96 |
| II | 2 | 2Q | 320 | 84 |
| III | 3 | 3Q | 350 | 83 |
| IV | 4 | 4Q | 370 | 82 |
| V | 5 | 5Q | 400 | 80 |

FIG. 10 is a plot of the tabularized data. Only the first five frames are shown in FIG. 10 since saturation was essentially reached within approximately ten (10) seconds.

The calculation of the intensity for data point I was as follows:

If the initial intensity was one-half full scale (where full scale was 2¹²=4096), a diminution of 90 pixels corresponds to ninety-six percent (96%) of the initial intensity.

Data Point I indicated that a quantity Q of ammonia that passed over the sample after two (2) seconds produced a diminution in intensity of ninety (90) units. The quantity Q was on the order of 3.5×10¹³ molecules of ammonia (the target gas).

Data Point II indicated that the quantity 2Q of ammonia that passed over the sample after four (4) seconds produced a diminution in intensity of three hundred twenty (320) units [eighty-four percent (84%) of the initial intensity].

Data Points III, IV and V respectively indicated that the respective quantities 3Q, 4Q and 5Q of ammonia that passed over the sample after six (6) seconds, eight (8) seconds and ten (10) seconds produced the corresponding diminutions in intensity listed.

From these data it is seen that if the various quantities of ammonia (the target gas) were contained in the same predetermined volume of a gas sample and that gas sample were passed over a given amount of sensor material, a unique corresponding diminution of reflected intensity would occur. The data show that there is a one-to-one correspondence between the ammonia concentration of gas (i.e., the amount of target gas in a predetermined sample volume) and the change in intensity produced thereby. There is a unique specific value of target gas concentration associated with each and every value of intensity.

Thus, a table of calibrated values relating concentration of target gas to a change in intensity of an optical property produced by the passage of a predetermined volume of a gas sample over a given amount of sensor material may be produced.

Those skilled in the art having the benefit of the teachings of the present invention may impart modifications thereto. Such modifications are to be construed as lying within the scope of the present invention, as defined by the appended claims.

What is claimed is:

1. A gas detector comprising:
(a) a predetermined amount of a sensor material having at least one optical property which changes as a result of reaction with a target gas; and
(b) a photometric device operable to measure the intensity of said at least one optical property of the sensor material,
the reaction being such that there is a one-to-one relationship between the magnitude of the intensity of the at least one optical property and the concentration of the target gas in the gas sample,
whereby the concentration of the target gas in the gas sample may be determined from the measured magnitude of the intensity of said at least one optical property after the passage of a predetermined volume of gas sample over the given area of sensor material.

2. A gas detector for detecting the presence of a target gas in a gas sample comprising:
(a) a detector cartridge comprising a substrate to which is attached two or more sensor materials each having at least one optical property which changes as a result of reaction with a target gas,
the reaction of each sensor material being such that there is a one-to-one relationship between the magnitude of the intensity of at least one optical property and the concentration of the target gas in the gas sample, whereby the concentration of each target gas in the gas sample may be determined from the measured magnitude of the intensity of said at least one optical property after the passage of a predetermined volume of gas sample over the given area of a respective sensor material;
(b) an air sampling system to provide an air sample to the detector cartridge;
(c) a photometric device to measure the change in intensity of said at least one optical property of each sensor material; and
(d) a display for displaying to a viewer the concentration of the target gas in the gas sample in accordance with the magnitude of the change in intensity of said at least one optical property of each sensor material is provided.

3. The gas detector of claim 2 wherein the substrate has at least one channel formed therein, and wherein each of the sensor materials is disposed in the one channel.

4. The gas detector of claim 3 wherein each of the sensor materials is responsive to the same target gas.

5. The gas detector of claim 3 wherein each of the sensor materials is responsive to a different target gas.

6. The gas detector of claim 2 wherein the substrate has a plurality of channels formed therein, and wherein one of the sensor materials is disposed in each channel.

7. The gas detector of claim 6 wherein each of the sensor materials is responsive to the same target gas.

8. The gas detector of claim 6 wherein each of the sensor materials is responsive to a different target gas.

9. The gas detector of claim 2 wherein the substrate has a plurality of channels formed therein, and wherein at least one of the sensor materials is disposed in each channel.

10. The gas detector of claim 2 wherein the substrate has at least one channel formed therein, and wherein a filter material is disposed in the one channel.

11. The gas detector of claim 2 wherein the substrate has a plurality of channels formed therein, and wherein a filter material is disposed in each channel.

12. A method for detecting a target gas in a gas sample comprising the steps of:
(a) contacting a gas sample having a target gas therein with a given area of a sensor material, the sensor material having at least one optical property that changes as a result of a reaction with the target gas, the reaction of the sensor material being such that there is a one-to-one relationship between the magnitude of the intensity of at least one optical property and the concentration of the target gas in the gas sample, whereby the concentration of each target gas in the gas sample may be determined from the measured magnitude of the intensity of said at least one optical property after the passage of a predetermined volume of gas sample over the given area of a respective sensor material;
(b) measuring the change in said at least one optical property of the sensor material as a result of contact with the target gas; and
(c) determining the concentration of the target gas in the gas sample from the measured magnitude of the intensity of said at least one optical property after the passage of the predetermined volume of gas sample over the given area of sensor material.
